(19) United States
(12) Patent Application Publication
(10) Pub. No.: US 2011/0048244 A1
(43) Pub. Date: Mar. 3, 2011

(54) APPARATUS AND METHOD FOR CONTROLLING A COMBUSTION BLOWER IN A GAS-FUELED CONVEYOR OVEN

(76) Inventor: John H. Wiker, Lockport, IL (US)

(21) Appl. No.: 12/550,034

(22) Filed: Aug. 28, 2009

(51) Int. Cl. A47J 37/00; F24C 15/00; A21B 1/48; G05D 23/00

(52) U.S. Cl. 99/331; 126/21 A; 99/443 C; 700/300

(57) ABSTRACT

A conveyor oven including a main blower, a modulating gas valve, and a combustion blower, and a method for operating the same. A conveyor moves food through a main cooking chamber. The modulating gas valve provides fuel to a gas burner, while a combustion blower provides air to the gas burner to aid in combustion of the fuel from the modulating gas valve. The main blower moves heated air into the main cooking chamber to cook food on the conveyor. In some embodiments, a controller adjusts the setting of the modulating gas valve and the speed of the main blower and the combustion blower, and determines an appropriate speed setting for the combustion blower based at least in part on the speed of the main blower and the measured temperature inside the conveyor oven.

### BACKGROUND

Conveyor ovens are commonly used for cooking a wide variety of food products, such as for cooking pizzas, baking and toasting bread, and the like. Examples of such ovens are shown, for example, in International Patent Application No. PCT/2009/030727, the entire contents of which are incorporated herein by reference.

Conveyor ovens typically have metallic housings with a heated tunnel extending therethrough, and one or more conveyors running through the tunnel. Each conveyor (in the form of a conveyor belt, for example) transports food items through the heated oven tunnel at a speed calculated to properly bake food on the conveyor belt during the time the conveyor carries the food through the oven. Conveyor ovens generally include a heat delivery system that may include one or more blowers supplying heated air to the tunnel, such as from a plenum to the tunnel. In some conveyor ovens, the hot air is supplied to the tunnel through passageways that lead to metal fingers discharging air into the tunnel at locations above and/or below the conveyor. The metal fingers act as airflow channels that deliver streams of hot air which impinge upon the surfaces of the food items passing through the tunnel on the conveyor. In modern conveyor ovens, a microprocessor-driven control can be employed to enable the user to regulate the heat provided to the tunnel, the speed of the conveyor, and other parameters to properly bake the food item being transported through the oven.

Some conveyor ovens include one or more gas burners positioned to heat air (e.g., in a plenum) before it is supplied to the tunnel to heat the food. In such ovens, the gas burner can include a modulating gas valve providing fuel to the burner, and a combustion blower providing enough air for efficient combustion of the fuel. An oven controller can monitor the temperature at one or more locations within the tunnel, and can adjust the modulating gas valve to provide more or less heat to the tunnel. If the measured temperature is lower than a set point temperature, the modulating gas valve is adjusted to supply more fuel. Conversely, if the measured temperature is higher than the set point temperature, the modulating gas valve is adjusted to supply less fuel. In some conventional ovens, the combustion blower and the modulating fuel valve are adjusted proportionally. For example, if the modulating fuel valve is adjusted to double the amount of fuel output, the speed of the combustion blower is also doubled.

### SUMMARY

As described above, current conveyor oven systems generally adjust the speed of a combustion blower in proportion to the setting of a modulating gas valve. However, such systems typically do not account for other external influences that may affect the efficiency of the gas burner. In some cases, air flow generated by a main blower that circulates air in the conveyor oven (e.g., between the tunnel and a plenum of the conveyor oven) can affect the speed and amount of air provided by the gas burner, thereby affecting the quality of the flame of the gas burner.

Some embodiments of the present invention provide a conveyor oven comprising a main blower that circulates air within a cooking chamber; at least one gas burner; a valve having a setting that determines an amount of gas provided to the gas burner; at least one combustion blower that provides air to the at least one gas burner; and a controller that monitors an internal temperature of the oven, adjusts the setting of the valve based at least in part on the internal temperature of the oven, adjusts a speed of the main blower, wherein the speed of the main blower includes at least a high speed setting and a low speed setting, and adjusts a speed of the at least one combustion blower based at least in part on at least one of the internal temperature of the oven and the speed of the main blower.

In some embodiments, the controller lowers the speed of the combustion blower when the main blower transitions from the low speed setting to the high speed setting, and/or increases the speed of the combustion blower when the main blower transitions from the high speed setting to the low speed setting. Also, in some embodiments, the controller determines an appropriate speed setting for the combustion blower by accessing a look-up table stored on a computer-readable memory. The look-up table can identify a plurality of speed settings based on internal oven temperature and main blower speed. In some embodiments, the controller calculates an appropriate combustion blower speed setting based on internal oven temperature and main blower speed.

Some embodiments of the present invention provide a method of controlling a combustion blower in a conveyor oven, wherein the method comprises measuring an internal temperature of the conveyor oven as determined by a temperature sensor; determining the speed of a main blower circulating air within an internal chamber of the conveyor oven; providing fuel to a burner within the conveyor oven through an electronically-controlled modulating fuel valve; controlling the output of the modulating fuel valve to adjust the internal temperature of the conveyor oven toward a set-point temperature; determining a speed setting for a combustion blower based at least in part on at least one of the measured internal temperature of the oven and the speed of the main blower; and operating the combustion blower at the determined speed setting.

Other aspects of the present invention will become apparent by consideration of the detailed description and accompanying drawings.

### BRIEF DESCRIPTION OF THE DRAWINGS

FIG. 1 is a perspective view of a conveyor oven in accordance with an embodiment of the invention.

FIG. 2 is a perspective view of a portion of the conveyor oven of FIG. 1, in which a hinged oven access panel has been opened to reveal some of the internal components of the oven.

FIG. 3 is a schematic illustration of an embodiment of the control system of the conveyor oven of FIGS. 1 and 2.

FIG. 4 is a diagrammatic representation of the tunnel of the oven of FIGS. 1-3.

FIG. 5 is a cross-sectional illustration of the internal compartments of the conveyor oven of FIGS. 1-4.

FIG. 6 is a diagrammatic representation of a gas burner of the conveyor oven of FIGS. 1-5.

FIG. 7 is a flowchart illustrating an energy management mode for the conveyor oven of FIGS. 1-6B.

FIG. 8 is a flowchart illustrating a method of controlling a combustion blower in the conveyor oven of FIGS. 1-7.

FIG. 9 is an example of a look-up table used to determine an appropriate speed of a combustion blower in the conveyor oven of FIGS. 1-8.

### DETAILED DESCRIPTION

Before any embodiments of the present invention are explained in detail, it is to be understood that the invention is not limited in its application to the details of construction and the arrangement of components set forth in the following description or illustrated in the following drawings. The invention is capable of other embodiments and of being practiced or of being carried out in various ways.

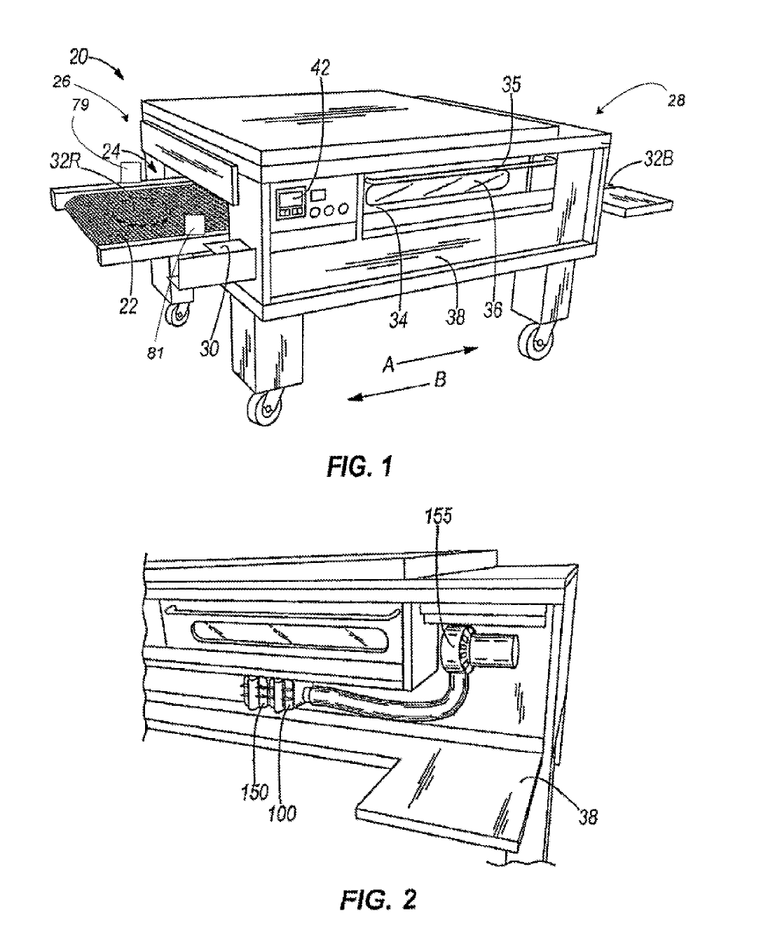

FIG. 1 shows a conveyor oven 20 having a conveyor 22 which runs through a heated tunnel 24 of the oven. The illustrated conveyor 22 has a width generally corresponding to the width of the heated tunnel 24, and is designed to travel in direction A from left oven end 26 toward right oven end 28 or, alternatively in direction B, from right oven end 28 toward left oven end 26. Thus, oven ends 26 and 28 may serve respectively as the inlet and outlet of an oven with a rightwardly moving conveyor or as the outlet and inlet of an oven with a leftwardly moving conveyor. Although the conveyor oven 20 illustrated in FIG. 1 has only a single conveyor 22, any number of additional conveyors in any desired arrangement can be used in other embodiments.

In some embodiments, the oven 20 can have one or more sensors positioned to detect the presence of food product on the conveyor 20 at one or more locations along the length of the conveyor 20. By way of example only, the oven 20 illustrated in FIG. 1 has photosensors 79, 81 positioned at the entrance of the oven tunnel 24 to detect the presence of a food item on the conveyor 22. In other embodiments, other types of sensors (e.g., other optical sensors, mechanical sensors, temperature sensors, and the like) can be positioned at the entrance of the oven tunnel 24, at any other location upstream of the oven tunnel 24, at the exit of the oven tunnel 24, at any other location downstream of the oven tunnel 24, and/or at any location within the tunnel 24. Such sensor(s) can be connected to a controller 42 (described in greater detail below) to trigger a change in operation of the conveyor 22, such as to start, stop, increase and/or decrease the output of one or more gas burners of the oven 20, start, stop, speed up, or slow down one or more blower fans of the oven 20, and/or start, stop, speed up or slow down the conveyor 22. In these cases, such changes can be initiated immediately upon detection of the food product at one or more locations along the conveyor 20, or can be initiated after a predetermined period of time (e.g., a programmed or otherwise set period of time) has passed.

The conveyor 22 can be implemented using conventional components and techniques such as those described in U.S. Pat. Nos. 5,277,105 and 6,481,433 and 6,655,373, the contents of which are incorporated herein by reference insofar as they relate to conveyor support, tracking, and drive systems and related methods. In the illustrated embodiment by way of example only, a chain link drive is housed within compartment 30 at the left end 26 of the oven. Thus, a food item 32R, such as a raw pizza or a sandwich (to be toasted), may be placed on the conveyor 22 of the ingoing left oven end 26, and removed from the conveyor 22 as a fully baked food item 32B at the outgoing right oven end 28. The speed at which the conveyor 22 moves is coordinated with the temperature in the heated tunnel 24 so that the emerging food item 32B is properly baked, toasted, or otherwise cooked.

A hinged door 34 is provided on the front of the oven 20 shown in FIG. 1, with a handle 35 and a heat resistant glass panel 36 permitting a person operating the oven to view a food item as it travels through the oven 20. In the illustrated embodiment, a stainless steel metal frame surrounds the oven opening, and provides a support for a gasket of suitable material (not shown), so that when the hinged door 34 is in its closed position, it fits against and compresses the gasket to retain heat in the oven 20. Also, the operator may open the door 34 by pulling on handle 35 to place a different product on the conveyor 22 if less than a full cooking cycle is required to produce a fully cooked product. A hinged oven access panel 38, open as shown in FIG. 2, provides access to internal components of the oven, such as gas burners 100, 150 and a combustion blower 155.

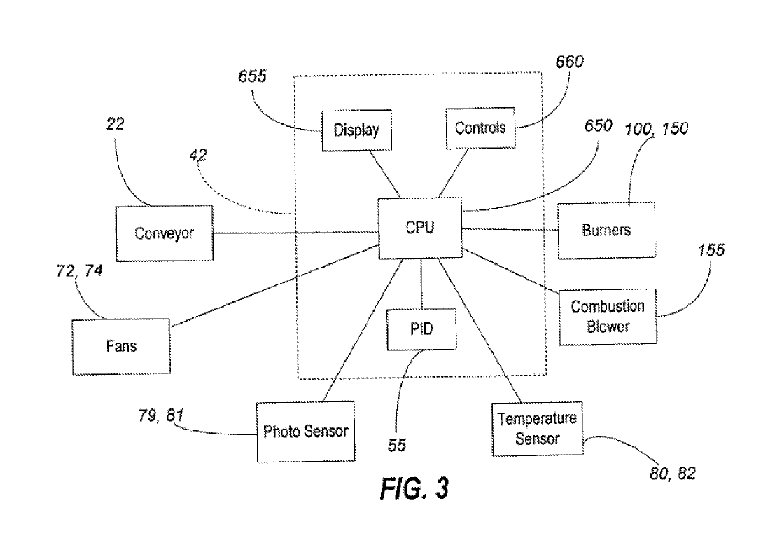

FIG. 3 illustrates a schematic example of a control system for the oven 20 shown in FIGS. 1 and 2. In the illustrated control system, a controller 42 includes one or more displays 655, and a control interface 660. The illustrated controller 42 also includes a central processing unit (“CPU”) 650 for controlling operation of a plurality of devices, including the gas burners 100, 150, two main blower fans 72, 74, the conveyor 22, and a combustion blower 155. The CPU 650 can be in the form of a microcontroller or programmable logic controller (PLC) with an associated memory unit in which software or a set of instructions is stored, can instead be defined by a plurality of discreet logic elements, or can take any other form suitable for control of the gas burners 100, 150, main blower fans 72, 74, conveyor 22, and combustion blower 155. The illustrated CPU 650 receives input from a plurality of sensors including one or more temperature sensors 80, 82 positioned inside the oven, and one or more photosensors 79, 81 (described above).

Although the oven 20 illustrated in FIGS. 1-3 includes two gas burners 100, 150 and two main blower fans 72, 74, any number of gas burners 100, 150 and blower fans 72, 74 can be used in other embodiments. In those embodiments in which two or more gas burners 100, 150 and/or two or more blower fans 72, 74 are used, the CPU 650 can control operation of the gas burners 100, 150 independently with respect to one another and/or can control operation of the blower fans 72, 74 independently with respect to one another, or otherwise.

The controller 42 in the illustrated embodiment adjusts the internal temperature of the oven using a PID (proportional—integral—derivative) control module 55 (also described in greater detail below). The PID control module 55 calculates an amount of fuel needed by the gas burners 100, 150 to raise the actual temperature toward a setpoint temperature, and the CPU 650 generates a command or signal to an amplifier board or signal conditioner that controls a modulating fuel valve to regulate the amount of fuel provided to each of the gas burners 100, 150.

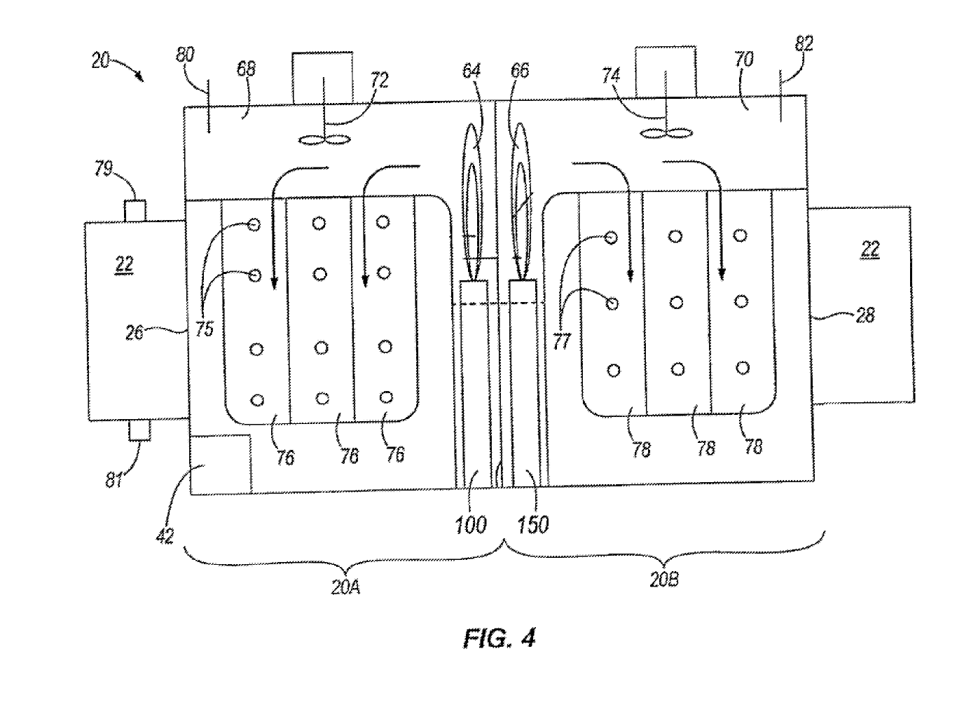

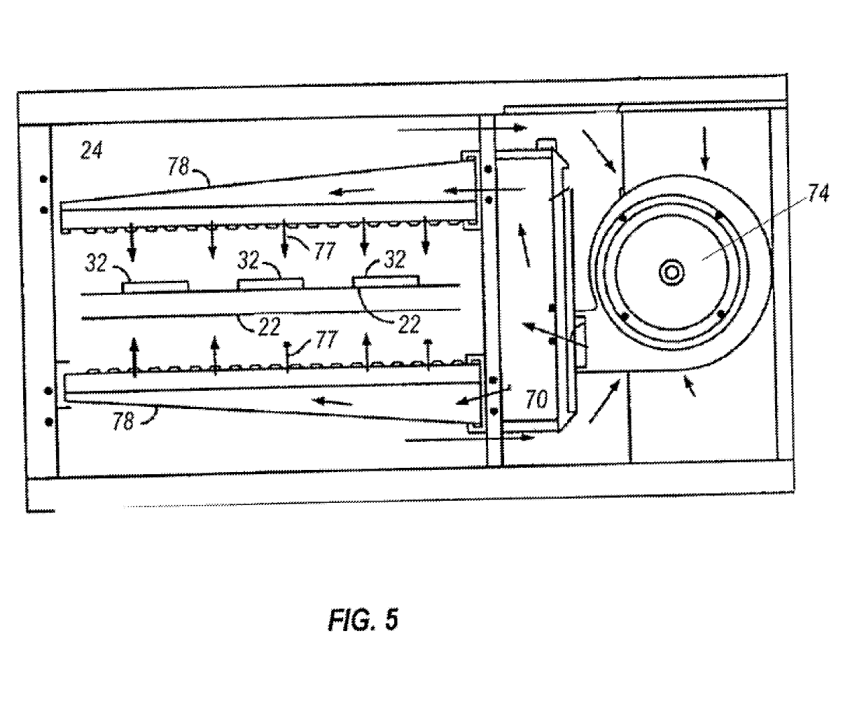

Heat delivery systems for supplying heat to the tunnel 24 are described generally in U.S. Pat. Nos. 5,277,105, 6,481,433 and 6,655,373, the disclosures of which are incorporated herein by reference insofar as they relate to heat delivery systems for ovens. As shown diagrammatically in FIG. 4 by way of example, the heat source for the conveyor oven 20 includes a pair of burners 100, 150 with respective heating flames 64, 66 supplying heat to respective independent plenums 68, 70 associated with segments 20A and 20B of the oven 20. The heated air from the plenums 68, 70 is blown into the two oven segments 20A, 20B by separate blower fans 72, 74 through holes (e.g., 75 and 77) in groupings of metal fingers 76, 78 associated with the respective oven segments 20A, 20B. The temperature in each tunnel segment 20A, 20B is monitored by a temperature sensor 80, 82. The temperature sensors 80, 82 can include a thermocouple, a thermistor, or any other type of temperature sensing element. The temperature sensors 80, 82 can be positioned in either the tunnel 24 or within the plenums 68, 70, and are connected to the controller 42.

The configuration of the conveyor oven 20 illustrated in FIG. 4 is presented by way of example only. In this regard, it will be appreciated that the conveyor oven 20 can have any number of tunnel segments 20A, 20B (including a single tunnel segment, or three or more tunnel segments), any number of temperature sensors 80, 82 located anywhere along the conveyor 22 (whether inside or outside the tunnel 24), any number of burners 100, 150, and any number of fingers 76, 78, sets of such fingers 76, 78, or other elements and devices for distributing heated air to desired locations above and/or below the conveyor 22. Also, although the illustrated conveyor oven 20 has two plenums 68, 70, heated air can instead be produced and moved through the conveyor oven 20 through any other number of plenums, and through appropriate ducts and conduits that are not necessarily identifiable as plenums 68, 70.

In some embodiments, the speed of the main blowers 72, 74 may be varied at times to reduce the amount of energy used by the conveyor oven 20 during periods of non-activity. To provide control over fan speed in these and other cases, the main blowers 72, 74 can be driven by variable-speed electric motors (not shown) coupled to and controlled by the controller 42. Power can be supplied to each variable-speed motor by, for example, respective inverters. In some embodiments, each inverter is a variable-speed inverter supplying power to the motor at a frequency that is adjustable to control the speed of the motor and, therefore, the speed of each of the main blowers 72, 74. An example of such an inverter is inverter Model No. MD60 manufactured by Reliance Electric (Rockwell Automation, Inc.). By utilizing variable speed motors supplied by power through respective inverters as just described, a significant degree of control over fan speed and operation is available directly via the controller 42 connected to other components of the control system. A similar motor control arrangement can also be used to control the speed of the combustion blower 155 (described in greater detail below), which functions to provide an appropriate level of air to the burners 100, 150 for proper combustion of fuel supplied to the burners 100, 150.

The main blowers 72, 74 described and illustrated herein can be located at any of a variety of locations with respect to the plenums 68, 70 of the oven 20, and can be used to pull and/or push air with respect to the plenums 68, 70 and/or the tunnel 24. For example, in some embodiments, the main blowers 72, 74 are positioned and oriented to draw air from the tunnel 24 into one of the plenums 68, 70. The suction caused by the main blowers 72, 74 lowers the air pressure in the tunnel 24 and increases the air pressure in the plenums 68, 70, thereby forcing heated air from the plenums 68, 70 into the tunnel 24 through the fingers 76, 78. In other embodiments, the main blowers 72, 74 are oriented to draw heated air from each of the plenums 68, 70 into the tunnel 24 through the metal fingers 76, 78.

An example of an orientation and layout of components in a conveyor oven 20 according to the present invention is shown in FIG. 5, which is a cross-sectional view of one of the oven segments 20B shown in FIG. 4. With reference to FIG. 5, a main blower 74 draws air from the tunnel 24 into the plenum 70. The air is heated in the plenum 70 and is forced back into the tunnel 24 through the metal fingers 78 due to the increased air pressure in the plenum caused by the main blower 74. Upper and lower metal fingers 78 extend above and below the conveyor 22 in the tunnel 24. Holes 77 on the upper and lower metal fingers 78 direct the heated air toward food items 32 that are located on the conveyor 22, thereby cooking the food items.

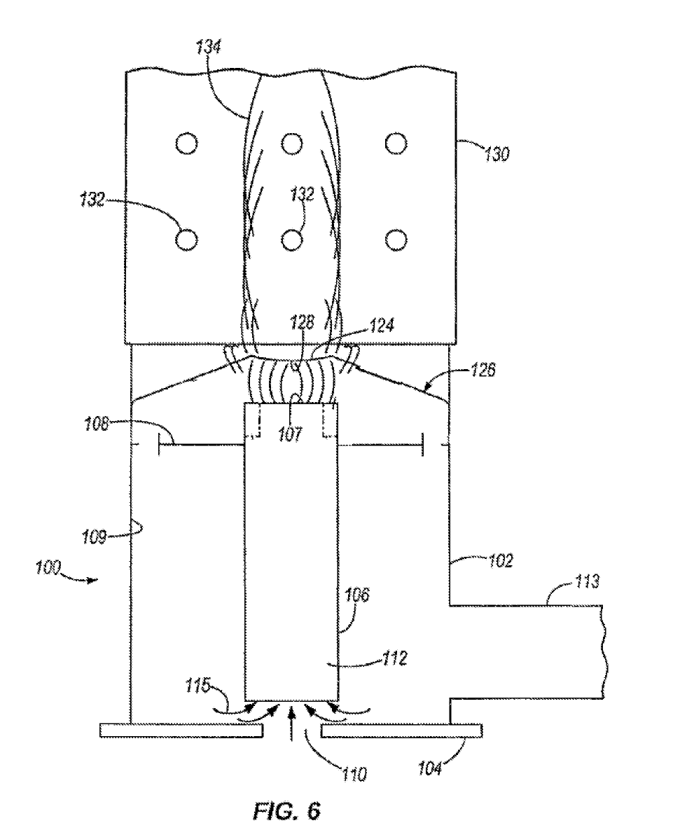

FIG. 6 illustrates a burner 100 of the oven 20 illustrated in FIGS. 1-5. The illustrated burner 100 comprises a housing (e.g., an outer tube 102 as shown in the illustrated embodiment) attached to a mounting plate 104 which closes off the proximal end of the outer tube 102. The outer tube 102 has a relatively elongated shape as shown in the illustrated embodiment. A smaller diameter venturi tube 106 is located within the outer tube 102, and has open distal and proximal ends 107, 112. The illustrated venturi tube 106 is generally centered with its longitudinal axis along the longitudinal axis of the outer tube 102, and is secured in place near its distal end 107 by a venturi support 108 encircling the venturi tube 106 and secured within the inside diameter 109 of the outer tube 102.

With continued reference to the illustrated embodiment of FIG. 6, a gas orifice 110 is located in the mounting plate 104, and is spaced from the proximal open end 112 of the venturi tube 106. Fuel is provided to the gas orifice 110 from a fuel source through an electronically-controlled modulating fuel valve (not shown). The open proximal end 112 of the venturi tube 106 receives pressurized gas from the gas orifice 110, and also serves as a primary air inlet to admit a flow of air 115 into the venturi tube 106. Powered air is supplied from the combustion blower 155 (see FIG. 3) to the outer tube 102 below the venturi support 108. The combustion blower 155 is coupled to the outer tube 102 in the illustrated embodiment via a conduit 113 leading to the outer tube 102.

The burner 100 illustrated in FIG. 6 also includes a target 124 with a surface 128 positioned opposite the distal end 107 of the venturi tube 106 and held in place by arms 126. In some embodiments, the outer tube 102 of the burner 100 is coupled to a flame tube 130, which can include a number of air openings 132, thereby supplying further oxygen to the burning gas supporting the flame 134.

The structure of the burner 100 illustrated in FIG. 6 allows the combustion blower 155 to provide air to the burner flame, enabling a proper mix of fuel and air necessary to achieve an optimal flame. If insufficient air is provided to the burner flame, the flame will not be able to burn the fuel, and may extinguish itself. If too much air is provided, the flame will lift off of the burner, and may extinguish. Therefore, the speed of the combustion blower 155 can be modulated to optimize the flame.

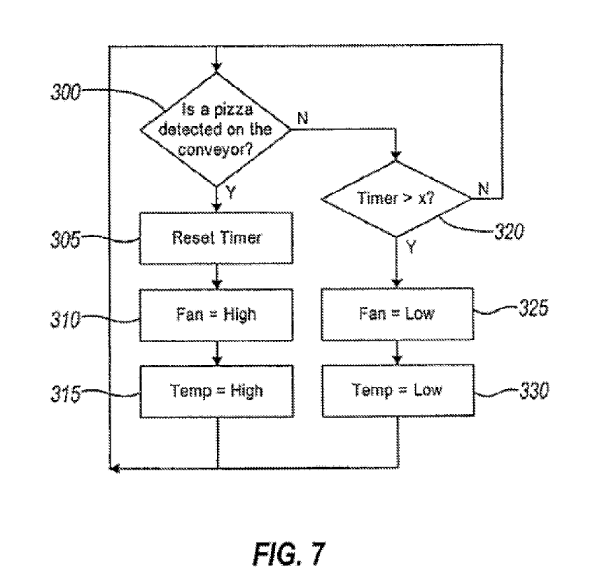

However, the speed of the combustion blower 155 is not the only variable that can affect the efficiency of the flame. The flame can also be adversely (or positively) affected by the speed of the main blowers 72, 74. For example, in some embodiments, the speed of the main blowers 72, 74 can be adjusted to save energy during operation of the oven—a change that can affect the efficiency of the flame. In the illustrated embodiment, the photosensor 79, 81 can be used to detect whether a food item has been placed on the conveyor 22 (see step 300 of FIG. 7). If a food item is detected, a timer is reset (step 305), the speed of the main blower 72, 74 is increased (e.g., set to high in step 310), and the setpoint temperature of the oven is also increased (e.g., the output of the modulating fuel valve is set to high in step 315). If no food item is detected on the conveyor and the timer exceeds a predefined threshold (step 320), the speed of the main blower 72, 74 is set to a lower energy-savings mode (step 325), and the temperature of the oven can be either decreased to a lower “energy-savings” set-point temperature (step 330) or maintained at the original set-point temperature. Additional and more detailed conveyor oven operations associated with such energy-savings modes are described in International Patent Application No. PCT/2009/030727, the entire disclosure of which is incorporated herein by reference.

When the timer illustrated in FIG. 7 expires, the amount of air provided to the burner 100, 150 can be automatically decreased as the speed of the main blower 72, 74 is decreased. Similarly, when a food item is later detected on the conveyor 22, the amount of air provided to the burner 100, 150 can be automatically increased as the speed of the main blower 72, 74 is increased. Either transition can adversely affect the quality of the burner flame, absent other adjustment of airflow provided to the burner 100, 150.

The temperature of the oven can also affect the rate at which air is circulated through the oven, independent or at least partially independent of the speed of the main blowers 72, 74. As the air increases in temperature, the air becomes less dense. Therefore, suction from one oven chamber to another (e.g., suction from an oven plenum to the tunnel, or vice versa) can gradually reduce as air temperature at different locations within the oven 20 increases or decreases. For example, as air temperature within the tunnel 24 of the oven 20 increases in the illustrated embodiment, air pressure within the tunnel 24 increases, thereby reducing the ability of air to move from the burners 100, 150 into the tunnel 24. Accordingly, increased air supply to the burners 100, 150 can be needed in order to maintain an optimal flame.

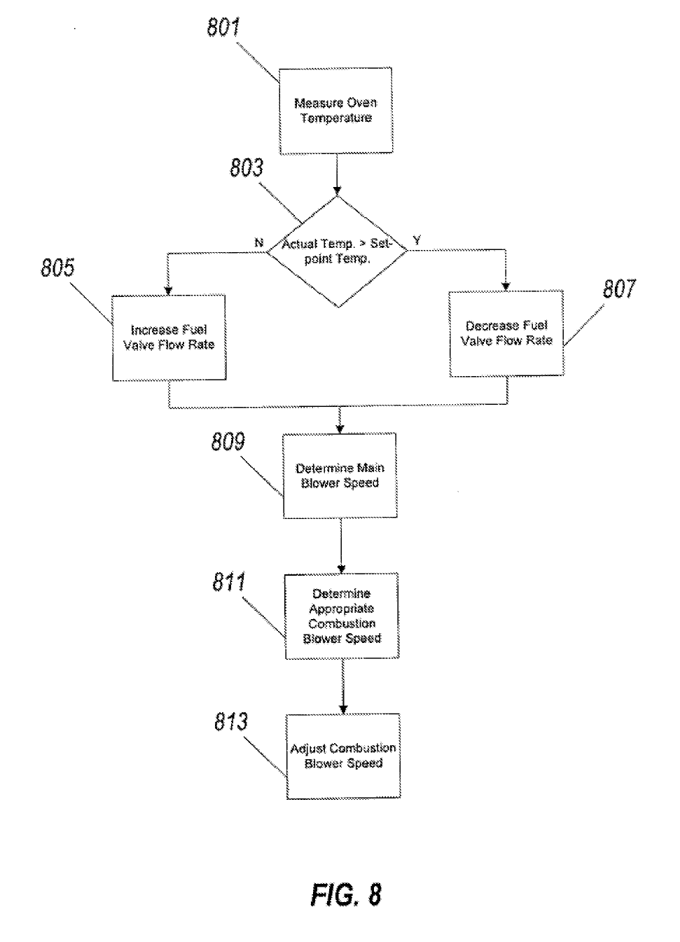

To address the changing needs of air supply to the burners 100, 150 based at least upon changes in main blower speed 72, 74, FIG. 8 illustrates a method of controlling the conveyor oven 20 based upon the speed of the main blowers 72, 74. The conveyor oven 20 described above in connection with FIG. 4 is divided into two segments in which blower speed and burner output are controlled separately. As such, the method illustrated in FIG. 8 is described by way of example only in reference to controlling the components associated with the first oven segment 20A of the conveyor oven 20. However, the method can also or instead be applied to any other segment of a conveyor oven, including in ovens that are not divided into separate oven segments.

With continued reference to FIG. 8, the controller 42 begins by monitoring the temperature sensor 80 (see FIG. 4) and measuring the oven temperature (step 801). If the actual temperature in the oven 20 is greater than the set-point temperature (step 803), the controller 42 decreases the flow rate of the modulating fuel valve (step 805) thereby decreasing the amount of fuel provided to the burner and decreasing the strength of the burner flame. Conversely, if the actual temperature in the oven 20 is less than the set-point temperature, the controller 42 increases the flow rate of the modulating fuel valve (step 807) thereby increasing the amount of fuel provided to the burner and increasing the strength of the burner flame.

As described above in reference to FIG. 7, the controller 42 can operate the main blower 72 to run the main blower 72 at a high-speed or lower-speed setting (and in some embodiments, at a number of other speeds or in any of a range of speeds). Therefore, in this embodiment, the controller 42 acts as a “feed-forward” system, and is able to determine the speed of the main blower 72 (step 809) without necessitating any additional sensor equipment. In other embodiments, a pressure sensor can be positioned adjacent or otherwise with respect to the main blower 72, or a motor speed sensor can be used to directly measure the speed of the main blower 72 (i.e., a “feedback” system).

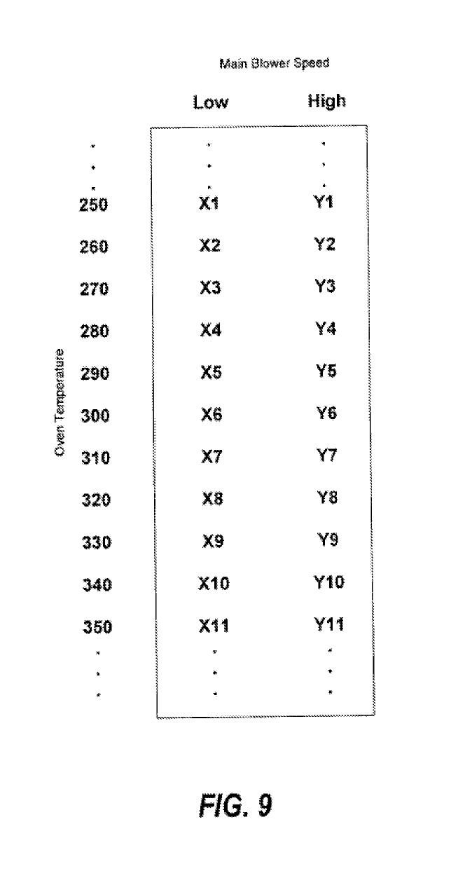

At this point, the controller 42 in the illustrated embodiment has already determined the internal temperature in the oven 20, the flow rate of the modulating fuel valve, and the speed of the main blower 72 (or these values are otherwise known or set). The controller 42 then uses this information to determine an appropriate speed for the combustion blower 155 (step 811). This determination can be reached in a number of different manners. In some embodiments, the controller 42 accesses a computer readable memory which stores a look-up table. As illustrated in FIG. 9, the look-up table identifies a series of combustion blower speeds based upon oven temperature and main blower speed. For example, if the oven temperature is measured as 290 degrees and the controller 42 is operating the main blower 72 at a high-speed setting, the look-up table defines Y5 as the appropriate combustion blower speed. Similarly, if the oven temperature is measured as 260 degrees and the controller 42 is operating the main blower 72 at the low-speed setting, the look-up table identifies X2 as the appropriate combustion blower speed.

The values of variables X1 through X11 and Y1 through Y11 will vary depending upon the size, shape, and configuration of the conveyor oven 20 and, therefore, can be specific to each conveyor oven model utilizing such a look-up table. Furthermore, some embodiments of the look-up table can include additional variables that affect the identified combustion blower speed. For example, in some look-up tables, the combustion blower speed setting can be based upon oven temperature, main blower speed, and the flow rate of the modulating fuel valve associated with the burner.

In other embodiments, the controller 42 determines the appropriate combustion blower speed by calculating a value. By way of example only, the value can be calculated by the controller based at least in part upon the following formula:

Combustion Blower Speed=(A×Gas Flow Rate)−(B×Main Blower Speed)+(C×Oven Temperature)

or by the following alternate formula:

Combustion Blower Speed=(A×Gas Flow Rate)−(B×Main Blower Speed)

or by the following alternate formula:

Combustion Blower Speed=(A×Gas Flow Rate)+(C×Oven Temperature)

wherein A, B, and C are coefficients determined at least in part upon the size, shape, and configuration of the conveyor oven 20 and components of the conveyor oven 20, such as the size and/or shape of the plenum 68, 70, the position of the combustion blower 155 with respect to the fingers 76, 78 and the plenum 68, 70, and the like.

With continued reference to FIG. 8, after the controller 42 has determined an appropriate speed for the combustion blower 155 (step 811), the controller 42 proceeds to operate the combustion blower 155 at that speed (step 813). The controller 42 can repeat the method illustrated in FIG. 8 periodically to continue to adjust the internal temperature of the conveyor oven 20 toward a set-point temperature while maintaining optimal flame conditions.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims. For example, although a specific type of burner is described above in connection with ovens according to the present invention, the invention can be applied to any type of gas burner system having other types of burners. As another example, the conveyor oven 20 can have any number of combustion blowers 155 corresponding to any number of burners 100, 150, and can have any number of main blower fans 72, 74, all of which can be located anywhere in the oven 20. In such embodiments, the CPU 650 can control operation of the gas burners 100, 150, the combustion blowers 155, and/or the blower fans 72, 74 independently with respect to one another or with respect to other components of the conveyor oven 20, or otherwise.

What is claimed is:

1. A conveyor oven comprising:
a main blower that circulates air within a cooking chamber;
at least one gas burner;
a valve adjustable to supply different amounts of gas to the gas burner;
a combustion blower that provides air to the at least one gas burner; and
a controller that
monitors an internal temperature of the oven,
adjusts an output of the valve based at least in part upon the internal temperature of the oven,
adjusts a speed of the main blower, and
adjusts a speed of the combustion blower based at least in part on at least one of the internal temperature of the oven and the speed of the main blower.

2. The conveyor oven of claim 1, wherein the controller lowers the speed of the combustion blower responsive to an increase in the speed of the main blower.

3. The conveyor oven of claim 1, wherein the controller increases the speed of the combustion blower responsive to a decrease in the speed of the main blower.

4. The conveyor oven of claim 1, wherein the controller adjusts the output of the valve based at least in part on the speed of the main blower.

5. The conveyor oven of claim 1, wherein the controller adjusts the output of the valve based at least in part upon the following formula:
Combustion Blower Speed=(A×Gas Flow Rate)−(B×Main Blower Speed)+(C×Oven Temperature)
wherein A, B, and C are coefficients reflective of features of the conveyor oven.

6. The conveyor oven of claim 1, wherein the controller includes a computer readable memory that stores a look-up table, and wherein the controller adjusts the speed of the combustion blower by determining the internal temperature of the oven, determining the speed of the main blower, and identifying an appropriate speed for the combustion blower from the look-up table based on the internal temperature of the oven and the speed of the main blower.

7. The conveyor oven of claim 1, wherein the controller determines the speed of the main blower based on a speed setting initiated by the controller.

8. The conveyor oven of claim 1, further comprising a pressure sensor positioned to measure air pressure generated by the main blower, and wherein the controller determines the speed of the main blower based on the air pressure measured by the pressure sensor.

9. The conveyor oven of claim 1, further comprising a temperature sensor communicative with and coupled to the controller, wherein the temperature sensor measures the internal temperature of the oven and provides the internal temperature measurement to the controller, and wherein the controller adjusts the setting of the valve based on the internal temperature measurement to adjust the internal temperature of the oven toward a set-point temperature.

10. The conveyor oven of claim 1, further comprising a plenum chamber, a main cooking chamber, and a conveyor that moves through the main cooking chamber, wherein the at least one gas burner is positioned to heat air in the plenum chamber, and wherein the main blower transfers air between the main cooking chamber and the plenum chamber.

11. A method of controlling a conveyor oven, comprising:
measuring an internal temperature of the conveyor oven as determined by a temperature sensor;
determining the speed of a main blower, wherein the main blower circulates air within an internal chamber of the conveyor oven;
providing fuel to a burner within the conveyor oven through a modulating fuel valve;
controlling the output of the modulating fuel valve to adjust the internal temperature of the conveyor oven; and
determining a speed setting for a combustion blower based at least in part on at least one of the measured internal temperature of the oven and the speed of the main blower.

12. The method of claim 11, wherein the act of determining the speed of the main blower includes determining the speed of the main blower.

13. The method of claim 12, wherein the act of determining the speed setting for the combustion blower includes decreasing the speed of the combustion blower when the main blower increases in speed.

14. The method of claim 12, wherein the act of determining the speed setting for the combustion blower includes increasing the speed of the combustion blower when the main blower decreases in speed.

15. The method of claim 11, wherein the act of controlling the output of the modulating fuel valve is based at least in part on the determined speed of the main blower.

16. The conveyor oven of claim 12, wherein the act of determining the speed setting for the combustion blower includes calculating the speed of the combustion blower based at least in part upon the following formula:
Combustion Blower Speed=(A×Gas Flow Rate)−(B×Main Blower Speed)+(C×Oven Temperature)
wherein A, B, and C are coefficients reflective of features of the conveyor oven.

17. The method of claim 12, wherein the act of determining the speed setting for the combustion blower includes:
accessing a look-up table stored on a computer-readable memory, and
identifying an appropriate speed setting for the combustion blower from the look-up table based on the measured internal temperature of the oven and the determined speed of the main blower.

18. The method of claim 11, wherein the act of determining the speed of the main blower includes accessing a speed setting initiated by a controller.

19. The method of claim 12, wherein the act of determining the speed of the main blower includes monitoring a pressure sensor positioned to measure air pressure generated by the main blower.

20. The method of claim 11, further comprising:
moving a conveyor through a main cooking chamber; and
circulating air between a plenum and the main cooking chamber by operating the a main blower.
